(19) United States
(12) Patent Application Publication
(10) Pub. No.: US 2026/0312174 A1
(43) Pub. Date: Oct. 8, 2026

(54) THERMAL MANAGEMENT FOR BATTERY PACK

(71) Applicant: Rivian IP Holdings, LLC, Irvine, CA (US)

(72) Inventors: Daniel Alfredo HERNANDEZ SAAB, Irvine, CA (US); Shubham Pradeep AGNIHOTRI, Irvine, CA (US); Youngbin LIM, Irvine, CA (US); Curtis Wesley CHAUVIN, Anaheim, CA (US)

(21) Appl. No.: 19/171,073

(22) Filed: Apr. 4, 2025

(51) Int. Cl. H01M 10/6552; H01M 10/613; H01M 10/615; H01M 10/625; H01M 10/6551; H01M 50/209; H01M 50/211; H01M 50/224; H01M 50/249

(52) U.S. Cl. CPC H01M 10/6552; H01M 10/613; H01M 10/615; H01M 10/625; H01M 10/6551; H01M 50/209; H01M 50/211; H01M 50/224; H01M 50/249; H01M 2200/103; H01M 2220/20

(57) ABSTRACT

An enclosure of a battery pack may include a thermally conductive portion that may function as both a housing and a heat sink for a battery pack. A thermal interface pad may be provided that thermally couples the thermally conductive portion of the enclosure to one or more heat-generating electrical components and/or thermally conductive members within the enclosure, for dissipation of heat via the enclosure. The thermal interface pad may electrically isolate the one or more heat-generating electrical components from the enclosure.

### INTRODUCTION

Batteries are often used as a source of power, including as a source of power for electric vehicles that include wheels that are driven by an electric motor that receives power from the battery.

### SUMMARY

Aspects of the subject technology relate to thermal management for battery packs. An enclosure of the battery pack may include a metal portion (e.g., casted or stamped housing structure) that may function as both a housing and a heat sink for the battery pack. A thermal interface pad may be provided that thermally couples the metal portion of the enclosure to one or more heat-generating electrical components and/or thermally conductive members within the enclosure, for dissipation of heat via the enclosure. The thermal interface pad may electrically isolate the one or more heat-generating electrical components from the enclosure.

The metal portion of the enclosure may include a feature integrally formed thereon for mounting the thermal interface pad between the metal portion of the enclosure and the one or more heat-generating electrical components. The battery pack may include a heat pipe structure, such as an aluminum insert in a molded bracket. The heat pipe structure may thermally couple the one or more heat-generating electrical components (e.g., busbars, shunts, pyrofuses, etc.) to the thermal interface pad. In one or more implementations, thermal management may be provided for a modular electronic component enclosure for the battery pack. For example, a modular electronic component enclosure may house or enclose power electronics for the battery pack. The modular electronic component enclosure may be a separate enclosure from an energy volume enclosure in which battery cells and/or battery subassemblies or modules containing battery cells are housed.

In accordance with aspects of the subject technology, a battery pack may include an enclosure that includes one or more metal housing structures. The battery pack may also include one or more heat-generating electrical components within the enclosure. The battery pack may also include a thermal interface pad on an internal surface of the metal housing structure. The battery pack may also include a thermally conductive member that extends between the one or more heat-generating electrical components and the thermal interface pad. The thermal interface pad may thermally couple the thermally conductive member to the metal housing structure. The thermal interface pad may also electrically isolate the thermally conductive member from the metal housing structure.

The thermal interface pad may be compressed between the thermally conductive member and the internal surface of the metal housing structure. The metal housing structure may be formed as a casted metal housing structure that includes an interface feature integrally formed on the internal surface of the metal housing structure. The thermal interface pad may be mounted on the interface feature.

In one or more implementations, the enclosure may include an enclosure for a modular electronic component assembly for the battery pack. The modular electronic component assembly may be configured to mechanically couple to an energy volume enclosure of the battery pack. The battery pack may also include a plurality of battery cells within the energy volume enclosure.

The battery pack may also include a bracket attached to the metal housing structure for supporting the one or more heat-generating electrical components. The thermally conductive member may be an overmolded insert in the bracket. The one or more heat-generating electrical components may include at least a pair of heat-generating electrical components that are stacked within the enclosure without a heat dissipating space therebetween. For example, the pair of heat-generating electrical components may include a pyrofuse and a shunt. The metal housing structure may include an external surface and a plurality of patterned casted features on the external surface, opposite a location of the thermal interface pad. The plurality of patterned casted features may provide an increased surface area on the external surface for heat dissipation.

In accordance with other aspects of the disclosure, a modular electronic component assembly may be provided that includes an enclosure that includes one or more metal housing structures, such as the metal housing structure. The modular electronic component assembly may also include one or more heat-generating electrical components within the enclosure. The modular electronic component assembly may also include a thermal interface pad on an internal surface of the metal housing structure. The modular electronic component assembly may also include a thermally conductive member that extends between the one or more heat-generating electrical components and the thermal interface pad. The thermal interface pad may thermally couple the thermally conductive member to the metal housing structure. The thermal interface pad may also electrically isolate the thermally conductive member from the metal housing structure.

In this example, the thermal interface pad of the modular electronic component assembly may be compressed between the thermally conductive member and the internal surface of the metal housing structure. In this example, the modular electronic component assembly may also include a bracket attached to the metal housing structure for supporting the one or more heat-generating electrical components. The thermally conductive member may be an overmolded insert in the bracket. In this example, the one or more heat-generating electrical components of the modular electronic component assembly may include at least a pair of heat-generating electrical components that are stacked within the enclosure without a heat dissipating space therebetween. For example, the pair of heat-generating electrical components of the modular electronic component assembly may include a pyrofuse and a shunt. In this example, the metal housing structure of the modular electronic component assembly may include an external surface and patterned casted features on the external surface, opposite a location of the thermal interface pad. The patterned casted features provide an increased surface area on the external surface for heat dissipation from the modular electronic component assembly.

In accordance with other aspects of the disclosure, a vehicle may be provided that includes a battery pack that includes an enclosure that includes one or more metal housing structures, such as the metal housing structure. The battery pack of the vehicle may also include one or more heat-generating electrical components within the enclosure. The battery pack of the vehicle may also include a thermal interface pad on an internal surface of the metal housing structure. The battery pack of the vehicle may also include a thermally conductive member that extends between the one or more heat-generating electrical components and the thermal interface pad. The thermal interface pad may thermally couple the thermally conductive member to the metal housing structure. The thermal interface pad may also electrically isolate the thermally conductive member from the metal housing structure.

In one or more implementations, the metal housing structure includes an external surface having a portion that is opposite a location of the thermal interface pad on the internal surface and that is exposed to an external environment of the vehicle. In one or more implementations, the enclosure includes an enclosure for a modular electronic component assembly for the battery pack of the vehicle. The modular electronic component assembly may be configured to mechanically couple to an energy volume enclosure of the battery pack of the vehicle. The battery pack of the vehicle may also include a plurality of battery cells within the energy volume enclosure. The battery pack of the vehicle may also include a bracket attached to the metal housing structure for supporting the one or more heat-generating electrical components. The thermally conductive member may be implemented as an overmolded insert in the bracket.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a schematic cross-sectional side view of a battery pack in accordance with one or more implementations.

FIG. 4 illustrates an exploded perspective view of a modular enclosure for one or more electrical components for a battery pack in accordance with one or more implementations.

FIG. 5 illustrates a top perspective view of a portion a metal housing structure in accordance with one or more implementations.

FIG. 6 illustrates a top perspective view of a portion a metal housing structure with a bracket thereon in accordance with one or more implementations.

FIG. 7 illustrates a top view of a portion of a modular electronic component assembly in accordance with one or more implementations.

FIG. 8 illustrates a cross-sectional side view of a portion of the modular electronic component assembly of FIG. 7 in accordance with one or more implementations.

FIG. 9 illustrates a cross-sectional top view of a portion of the modular electronic component assembly of FIG. 7 in accordance with one or more implementations.

FIG. 10 illustrates a bottom perspective view of a portion of an enclosure of a battery pack in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

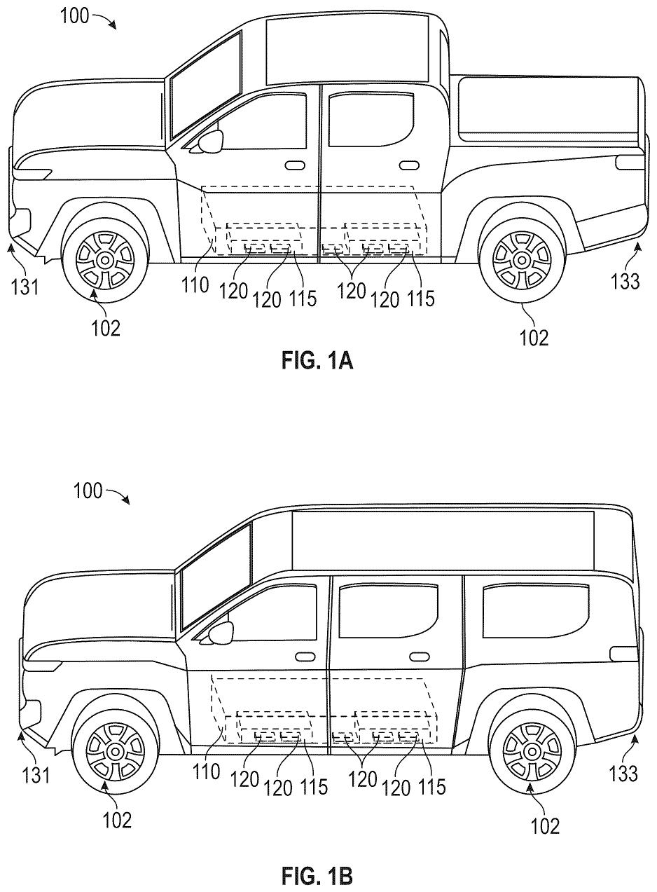

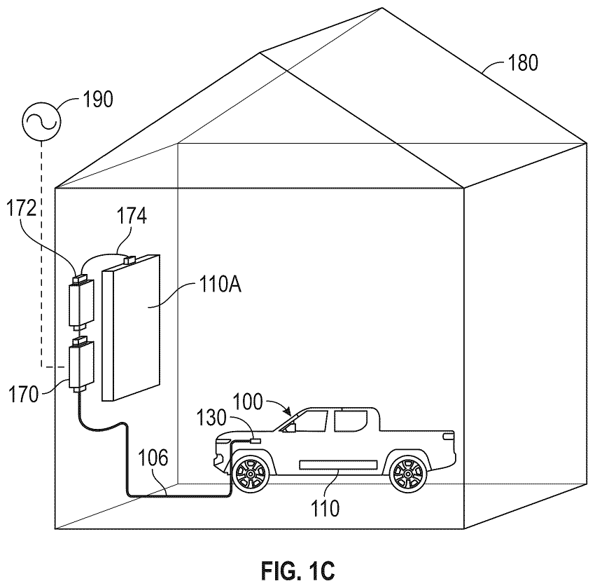

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into battery subassemblies, such as battery modules or battery units. A battery unit or module can include an assembly of cells that can be combined with other elements (e.g., structural frame, thermal management devices) that can protect the assembly of cells from heat, shock and/or vibrations.

For example, the battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100. The vehicle 100 may have a front end 131 and a rear end 133.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

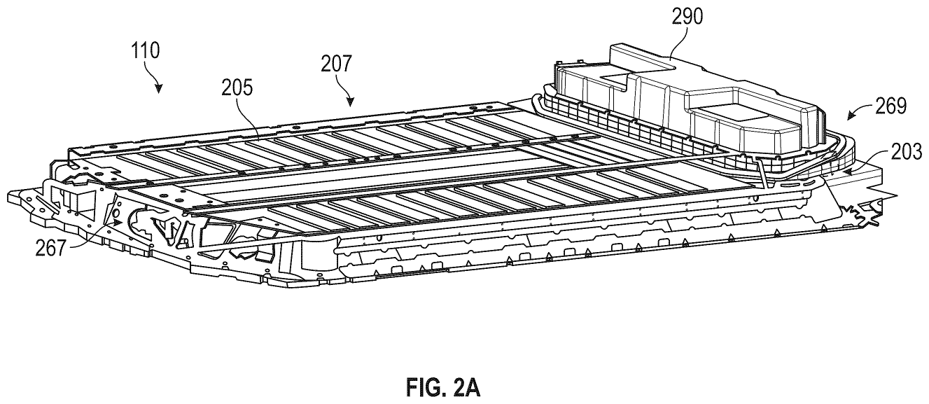

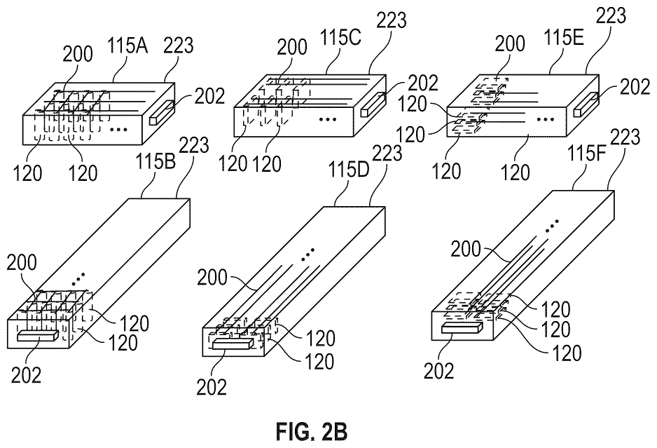

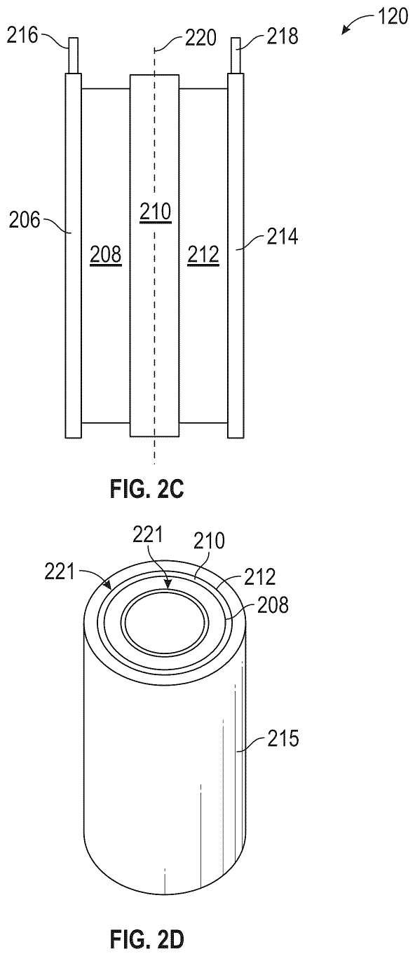

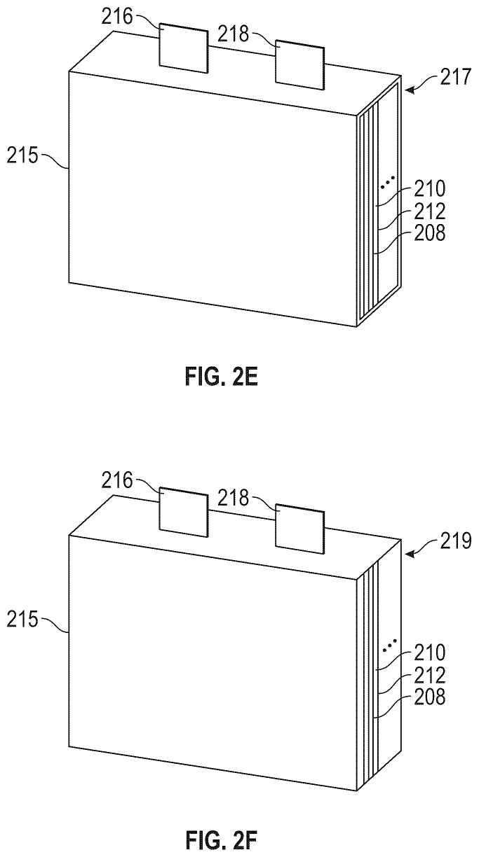

FIG. 2A depicts an example battery pack 110, in accordance with one or more implementations. As shown, the battery pack 110 may include an energy volume enclosure 205 (e.g., a battery pack housing or pack frame). For example, the energy volume enclosure 205 may house or enclose an energy volume 207 for the battery pack 110, the energy volume 207 including one or more battery modules 115 and/or one or more battery cells 120, and/or other battery pack components. In one or more implementations, the energy volume enclosure 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

Battery pack 110 may include, within the energy volume 207 and the energy volume enclosure 205, multiple battery cells 120 (e.g., directly installed within the battery pack 110, or within batteries, battery units, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the energy volume enclosure 205 to generate a desired output voltage for the battery pack 110.

As shown, the battery pack 110 may also include a modular enclosure 290 (e.g., a modular electronic component enclosure or a modular electrical component enclosure) mounted to the energy volume enclosure 205. In one or more implementations, the modular enclosure 290 may include one or more of the conductive coupling elements for routing power from the battery cells 120 and/or battery modules 115 within the energy volume enclosure 205 (e.g., within the energy volume 207) to one or more external connection ports, such as electrical contact 203 (e.g., a high voltage terminal, port, or connector). For example, an electrical cable or harness may be connected between the electrical contact 203 and an electrical system of the vehicle 100 or the building 180, to provide electrical power to the vehicle 100 or the building 180. The energy volume enclosure 205 may have a front end 267 and a rear end 269. In one or more implementations, when the battery pack 110 is installed in the vehicle 100, the battery pack 110 may be arranged with the front end 267 closer to the front end 131 of the vehicle and the rear end 269 closer to the rear end 133 of the vehicle. As shown, the modular enclosure 290 may be mounted to the energy volume enclosure 205 at or near the rear end 269 in one or more implementations.

In one or more implementations, the battery pack 110 may include one or more additional features, such as thermal control structures (e.g., cooling lines and/or plates and/or heating lines and/or plates). For example, thermal control structures may couple thermal control structures and/or fluids to the battery modules 115, battery units, batteries, and/or battery cells 120 within the energy volume enclosure 205, such as by distributing fluid through the battery pack 110.

For example, the thermal control structures may form a part of a thermal/temperature control or heat exchange system that includes one or more thermal components such as plates or bladders that are disposed in thermal contact with one or more battery modules 115 and/or battery cells 120 disposed within the energy volume enclosure 205. For example, a thermal component may be positioned in contact with one or more battery modules 115, battery units, batteries, and/or battery cells 120 within the energy volume enclosure 205. In one or more implementations, the battery pack 110 may include one or multiple thermal control structures and/or other thermal components for each of several top and bottom battery module pairs. As shown, the battery pack 110 may include an electrical contact 203 (e.g., a high voltage connector or port) by which an external load (e.g., the vehicle 100 or an electrical system of the building 180) may be electrically coupled to the battery modules and/or battery cells in the battery pack 110.

FIG. 2B depicts various examples of battery modules 115 that may be disposed in the battery pack 110 (e.g., within the energy volume enclosure 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the energy volume enclosure 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the energy volume enclosure 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the energy volume enclosure 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the energy volume enclosure 205) may include or define a plurality of structures for positioning of the battery cells 120 directly within the energy volume enclosure 205.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the electrolyte 210 may be a liquid electrolyte layer or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, sodium ion battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 215 having a cylindrical outer shape. For example, the anode 208, the electrolyte 210, and the cathode 212 may be rolled into one or more substantially cylindrical windings 221. As shown, one or more windings 221 of the anode 208, the electrolyte 210, and the cathode 212 (e.g., and/or one or more separator layers such as separator layer 220) may be disposed within the cell housing 215. For example, a separator layer may be disposed between adjacent ones of the windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 215 having a right prismatic outer shape. As shown, one or more layers of the anode 208, the cathode 212, and the electrolyte 210 disposed therebetween may be disposed (e.g., with separator materials between the layers) within the cell housing 215 having the right prismatic shape. As examples, multiple layer of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 215 having the right prismatic shape. In the implementation of FIG. 2E, the cell housing 215 has a relatively thick cross-sectional width 217 and is formed from a rigid material. For example, the cell housing 215 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 215 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 215 (e.g., a glass to metal feedthrough) as the conductor passes through to cell housing 215 to expose the first terminal 216 and the second terminal 218 outside the cell housing 215 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the electrolyte 210 disposed therebetween may be disposed (e.g., with separator materials between the layers) within the cell housing 215 that forms a flexible or malleable pouch housing. In the implementation of FIG. 2F, the cell housing 215 has a relatively thin cross-sectional width 219. For example, the cell housing 215 in the implementation of FIG. 2F may be formed from a flexible or malleable material (e.g., a foil, such as a metal foil, or film, such as an aluminum-coated plastic film). For example, the cross-sectional width 219 of the cell housing 215 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 215 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or different sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included in a battery module 115 or a battery pack 110, such as to provide an electrical power supply for components of the vehicle 100, the building 180, or any other electrically powered component or device. The cell housing 215 of the battery cell 120 can be disposed in the battery module 115, the battery pack 110, or installed in any of the vehicle 100, the building 180, or any other electrically powered component or device.

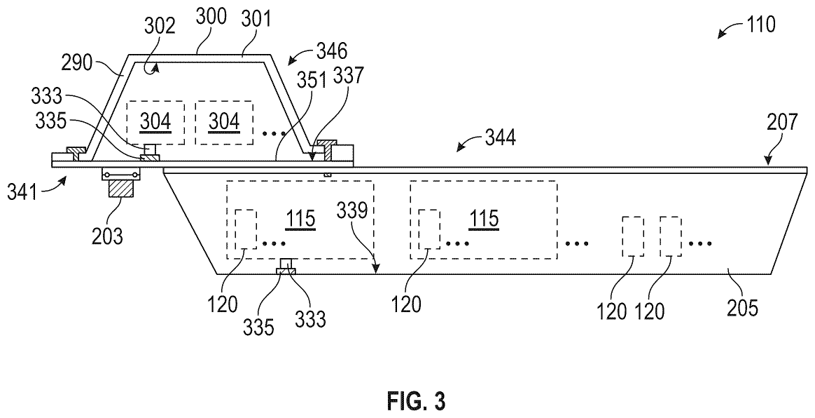

FIG. 3 illustrates a schematic cross-sectional side view of a battery pack in accordance with one or more implementations of the subject technology. As shown in FIG. 3, the battery pack 110 may include an enclosure 344. The enclosure 344 may include the energy volume enclosure 205 of the energy volume 207, and the modular enclosure 290 (e.g., also referred to herein as a modular electronic component assembly enclosure) of a modular electronic component assembly 346. As shown, the energy volume 207 may include the energy volume enclosure 205 and one or more battery modules 115 and/or battery cells 120 therewithin. The modular enclosure 290 may enclose, or house, one or more electrical components 304 for the battery pack 110. For example, the modular enclosure 290 may be configured to mechanically and electrically couple to the energy volume 207 of the battery pack 110. For example, the electrical components 304 (e.g., a high voltage distribution bus, one or more pyrofuses, one or more shunts, electrical cabling, and/or one or more other electrical and/or electronic components, and/or the like) that are disposed within the modular enclosure 290 may be configured to route power (e.g., a high voltage output and/or a low voltage output) from the battery modules 115 and/or battery cells 120 within the energy volume 207 to one or more ports on the enclosure, such as the electrical contact 203.

In one or more implementations, the enclosure 344 (e.g., the energy volume enclosure 205 and/or the modular enclosure 290) may be used as a heat sink for the battery pack 110. For example, the electrical components 304 within the modular enclosure 290 and/or the battery cells 120 and/or battery modules 115 within the energy volume enclosure 205 may be heat-generating electrical components that generate heat (e.g., as an unintended effect of operation for a primary purpose) during delivery of electrical power from the battery cells 120. As shown, the battery pack 110 may include one or more thermal interface pads 335 on one or more internal surfaces of the enclosure 344 (e.g., a thermal interface pad 335 on an interior surface 337 of the modular enclosure 290, and/or a thermal interface pad 335 on an interior surface 339 of the energy volume enclosure 205). As shown, the battery pack 110 may also include one or more a thermally conductive members 333 (e.g., heat pipe structures) that extend between one or more heat-generating electrical components (e.g., the electrical components 304 in the modular enclosure 290, and/or the battery cells 120, and/or the battery modules 115 in the energy volume enclosure 205) and the thermal interface pads 335. For example, the thermal interface pads 335 may thermally couple the thermally conductive members 333 to one or more metal housing structures of the enclosure 344 (e.g., to a metal housing structure 351 of the modular enclosure 290). In this way, the energy volume enclosure 205 and/or the modular enclosure 290 may be used as a heat sink for the battery pack.

In one or more implementations, the thermally conductive members may also be electrically conductive members (e.g., formed from a metal, such as aluminum and/or copper). The thermal interface pads 335 may thermally couple the thermally conductive members 333 to metal housing structures of the modular enclosure 290 and/or the energy volume enclosure 205, and may electrically isolate the thermally conductive members 333 from the metal housing structures of the modular enclosure 290 and/or the energy volume enclosure 205.

As shown, in one or more implementations, a portion 341 of the modular enclosure 290 may extend beyond (e.g., hang over) an edge of the energy volume enclosure 205. The thermal interface pad 335 may contact the interior surface 337 of the modular enclosure 290 at a location that is opposite at least part of the portion 341 that overhangs, and/or extends beyond, the edge of the energy volume enclosure 205. In one or more implementations, the battery pack 110 may be mounted in a vehicle or other apparatus, such as the vehicle 100, such that the portion 341 is exposed to the external environment (e.g., the air around the vehicle) of the vehicle or other apparatus, to allow heat to dissipate from the portion 341 into the external environment. For example, other portions of the enclosure 344 may face and/or be exposed to an internal environment of the vehicle (e.g., a passenger cabin or storage space), and may therefore be less effective as a heat sink than the portion 341.

In one or more implementations, the modular enclosure 290 may include an access panel 300. The access panel 300 may include, for example, a solid insulating structure 301 configured to at least partially cover the electrical components 304, and a conductive layer 302 on a surface of the solid insulating structure 301. The solid insulating structure 301 may be formed from any solid insulating material including, as examples, plastic or reinforced plastic. In some implementations, the solid insulating structure 301 may include, or be replaced with, one or more conductive materials, such as magnesium.

Because the electrical components 304 are provided in a modular enclosure 290 that is removably attachable to the energy volume 207, the enclosure and its electrical components 304 can be installed, serviced, and/or leak checked separately from the battery modules 115 and/or battery cell 120, without affecting EMI/EMC, grounding, and structural performance. For example, the modular enclosure 290 and its electrical components 304 may be assembled and tested separately for electrical and leak checks, and/or heat sinking.

In one or more implementations, the modular enclosure 290 provides a single enclosure for the electrical components 304 of the battery pack 110, and acts as a shield for EMI/EMC. In one or more implementations, the modular enclosure 290 is provided in a modular form that can be connected to energy volumes of various sizes and that include battery cells of any of various cell chemistries. In the example of FIG. 3, the electrical contact 203 (e.g., a high voltage port) is disposed on the portion 341 of the modular enclosure 290 that overhangs the end of the energy volume enclosure 205.

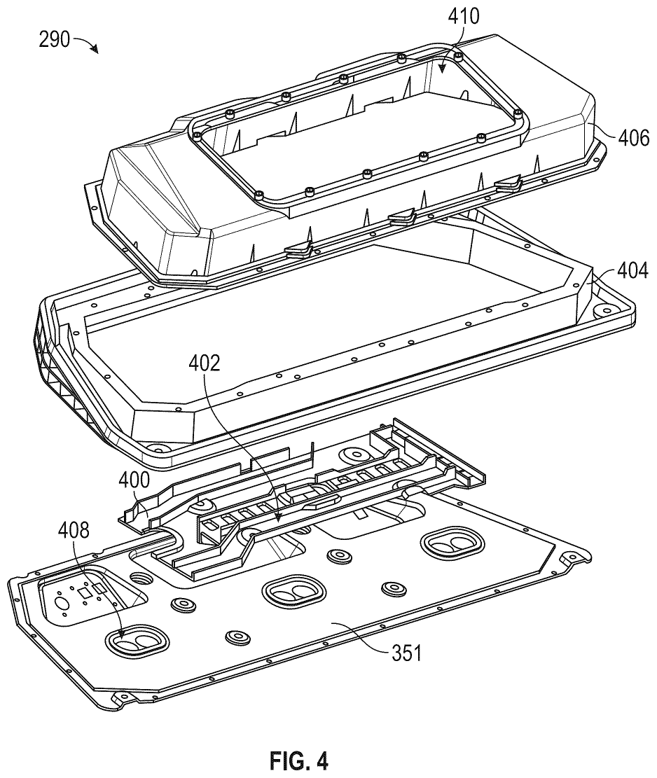

FIG. 4 illustrates an exploded perspective view of the modular enclosure 290, in accordance with one or more implementations. As shown in FIG. 4, the metal housing structure 351 may form a tray for the modular enclosure 290. For example, the tray may be configured for mounting one or more of the electrical components 304 thereto. In one or more implementations, a bracket 400 may be mounted and/or attached to the metal housing structure 351. For example, the bracket 400 may include on or more features 402 for supporting and/or mounting the electrical components 304. In one or more implementations, the bracket 400 may be a molded bracket, which may be formed from molded materials, such as molded plastic or other polymer materials. As discussed in further detail hereinafter, one or more thermally conductive members 333 may be implemented as overmolded inserts in the bracket 400, in some implementations.

In the example of FIG. 4, the modular enclosure 290 includes an access panel 406. The access panel 406 may be removable for access to the electrical components 304 within the modular enclosure 290, and/or the access panel 406 may include one or more openings 410 that may function as access ports to the electrical components 304, when the electrical components 304 are installed within the modular enclosure 290. In the example of FIG. 4, the modular enclosure 290 includes a tub 404 interposed between the access panel 406 and the metal housing structure 351. However, this is merely illustrative and, in other implementations, the access panel 406 may mount directly to the metal housing structure 351. As shown in FIG. 4, the metal housing structure 351 may include various features, including openings 408 that accommodate one or more electrical connections between the battery cells 120 and/or battery modules 115 in the energy volume enclosure 205 and the electrical components 204 in the modular enclosure 290.

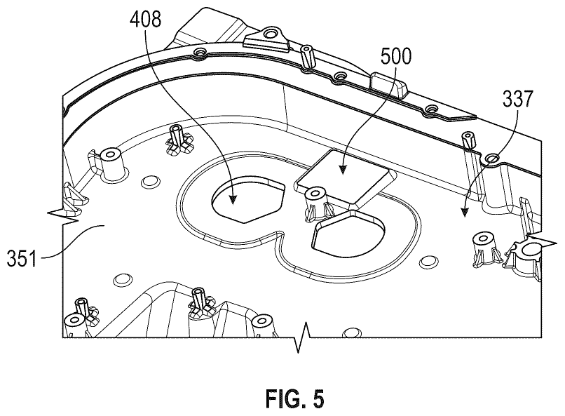

FIG. 5 illustrates a portion of the metal housing structure 351 in accordance with one or more implementations. As shown in FIG. 5, the metal housing structure 351 may include an interface feature 500. For example, the interface feature 500 may be integrally formed on the interior surface 337 of the metal housing structure 351. For example, the metal housing structure 351 may be a casted metal housing structure, and the interface feature 500 may be formed as an integral feature of the metal housing structure 351 in the casting process. For example, the interface features 500 may be a casted platform feature and/or a pocket having a shape that is similar in shape to the thermal interface pad 335. In one or more implementations, the thermal interface pad 335 of FIG. 3 may be mounted on the interface feature 500.

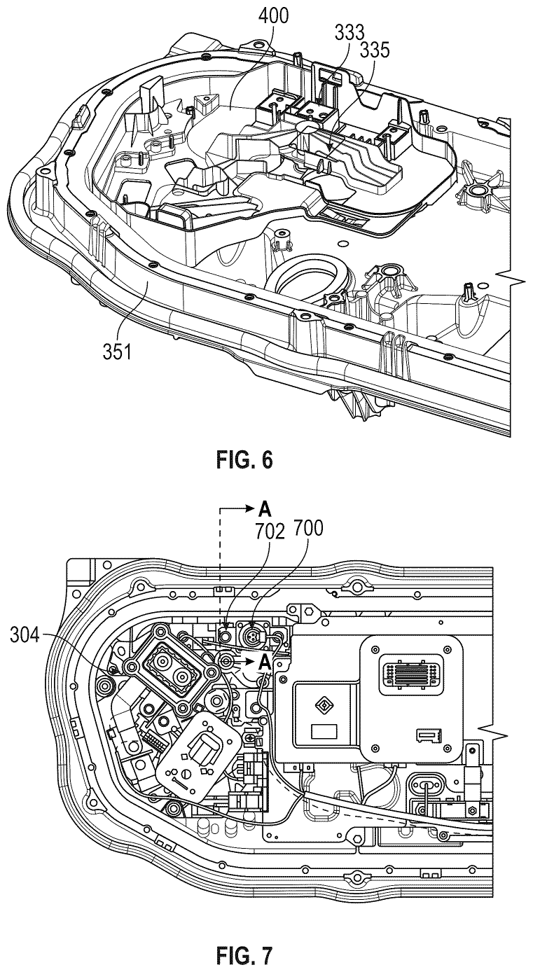

FIG. 6 illustrates a portion of the metal housing structure 351 with the bracket 400 mounted thereon. In this example, a top portion of a thermally conductive member 333 that is overmolded in the bracket 400 is visible. Although the thermal interface pad 335 would not be visible in the view of FIG. 6, the location of the thermal interface pad 335 (e.g., under the bracket 400) is highlighted in FIG. 6.

FIG. 7 illustrates a top view of the modular electronic component assembly 346 with the access panel removed to allow a view of the electrical components 304. For example, the electrical components 304 may include a one or more pyrofuses, such as pyrofuse 700, and one or more shunts, such as a shunt 702. As shown, the pyrofuse 700 and the shunt 702 may be disposed in close proximity to each other (e.g., in contact with each other) and without a heat dissipating space therebetween. Thus, a heat sink formed by the thermally conductive member 333, the thermal interface pad 335, and the metal housing structure 351 may be particularly helpful in the vicinity of the pyrofuse 700 and the shunt 702. As shown, the electrical components 304 of the modular electronic component assembly 346 may include other electrical components, such as busbars, cabling, a high-voltage distribution box, and/or other electrical components. Heat from these other electrical components may also be thermally sunk to the metal housing structure 351.

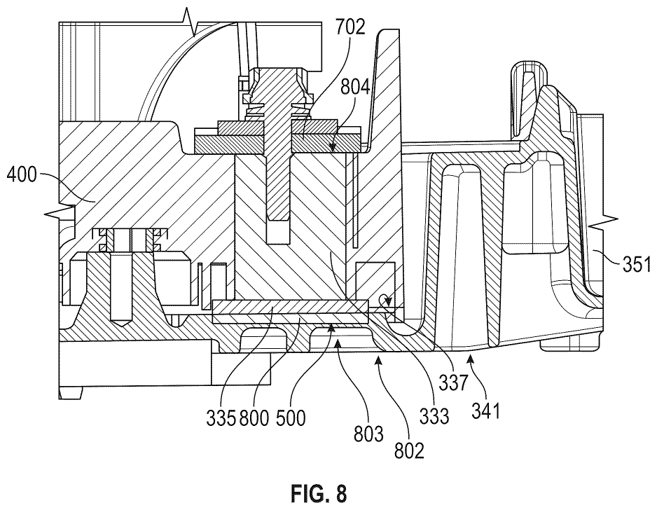

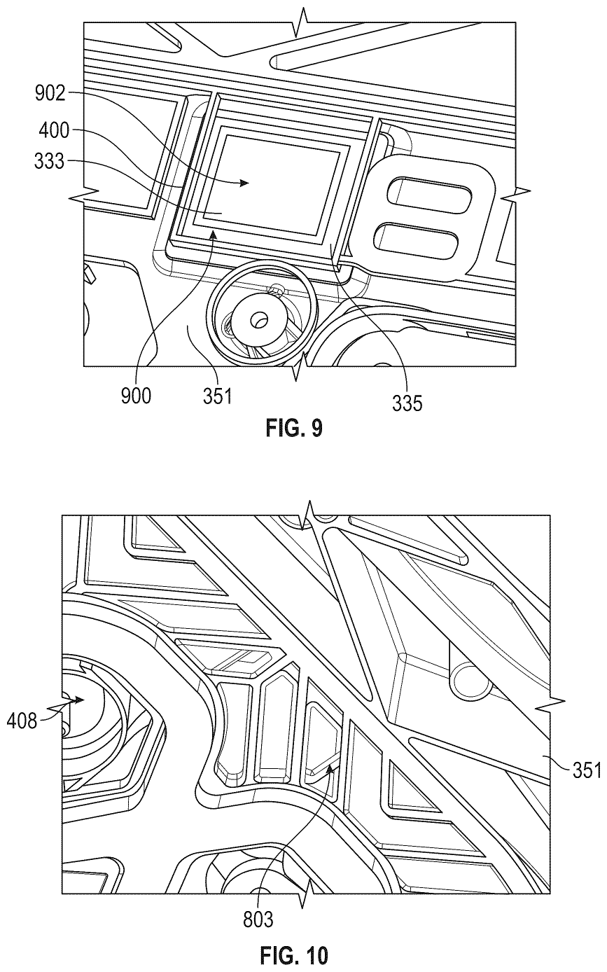

FIGS. 8 and 9 illustrate cross-sectional views of the modular electronic component assembly 346 of FIG. 7, with the cross-sections taken along the line A-A of FIG. 7. FIG. 8 illustrates a cross-sectional side view, and FIG. 9 illustrates a cross-sectional top view. As shown in FIG. 8, the bracket 400 may be molded around the sides of the thermally conductive member 333. As shown, a top surface 804 of the thermally conductive member 333 may be exposed, and may contact one or more electrical components 304, such as the shunt 702, in order to conduct heat away from the electrical component(s) with which it is in contact. A bottom of the thermally conductive member 333 may contact the thermal interface pad 335. As shown, an exterior surface 802 of the portion 341 of the metal housing structure 351 may include surface features 803. For example, the surface features 803 may be located opposite the location of the thermal interface pad 335 on the interior surface 337, and may increase a surface area of the exterior surface 802 at least in that portion of the metal housing structure 351. In this way, the surface features 803 may increase the ability of the metal housing structure 351 to dissipate heat to the external environment.

The thermal interface pad 335 may be formed from a thermally conductive and electrically isolating material, such as silicone. For example, the thermal interface pad 335 may have an uncompressed thickness of between three millimeters (mm) and seven mm. The thermal interface pad 335 may be installed in a gap, between the thermally conductive member 333 and the metal housing structure 351, that is smaller than the thickness of the thermal interface pad 335, so that the thermal interface pad 335 is compressed between the thermally conductive member 333 and the metal housing structure 351 when the modular electronic component assembly 346 is assembled. In one or more implementations, the thermal interface pad 335 may be compressed to a thickness of between 1.5 mm and 3.75 mm when the modular electronic component assembly 346 is assembled. For example, the thermal interface pad 335 may have a Shore hardness of between 30 and 70, to allow the thermal interface pad 335 to be compressed between the thermally conductive member 333 and the metal housing structure 351 when the modular electronic component assembly 346 is assembled.

The thermal interface pad 335 may, for example, have a thermal conductivity of greater than five Watts per milliKelvin (W/mK) in some implementations, for transfer of heat from the thermally conductive member 333 to the metal housing structure 351. The thermal interface pad 335 may, for example, have a dielectric breakdown voltage of greater one thousand volts (V) or greater than three thousand volts. The thermal interface pad 335 may, for example, have a Comparative Tracking Index (CTI) of greater than 175. The thermal interface pad 335 may, for example, have a UL 94 flame rating of V0. The thermal interface pad 335 may, for example, have an operating temperature range of between negative fifty degrees Celsius and positive one hundred fifty degrees Celsius.

As illustrated in FIG. 8, a portion 800 of the thermal interface pad 335 may extend into the interface feature 500 (e.g., a casted pocket) on the interior surface 337 of the metal housing structure 351. In one or more implementations, an end (e.g., a bottom end) of the thermally conductive member 333 may compress a central portion of the thermal interface pad 335, such that a peripheral portion of the thermal interface pad 335 wraps around and is disposed above the end of the thermally conductive member 333. For example, in the cross-sectional top view of FIG. 9, a peripheral portion 900 of the thermal interface pad 335 can be seen in the same cross-sectional plane with a cut through an end portion 902 of the thermally conductive member 333. Portions of the bracket 400 in this same plane are also visible in FIG. 9. FIG. 10 illustrates a bottom view of the metal housing structure 351, in which the surface features 803 are visible.

As illustrated in FIGS. 1A-10, a battery pack 110 may include an enclosure 344 (e.g., including modular enclosure 290 and energy volume enclosure 205) that includes one or more metal housing structures, such as the metal housing structure 351. The battery pack 110 may also include one or more heat-generating electrical components (e.g., battery modules 115, battery cells 120, electrical components 304, pyrofuse 700, shunt 702, and/or other electrical components) within the enclosure. The battery pack 110 may also include a thermal interface pad 335 on an internal surface (e.g., interior surface 337 or interior surface 339) of the metal housing structure. The battery pack 110 may also include a thermally conductive member 333 that extends between the one or more heat-generating electrical components and the thermal interface pad 335. The thermal interface pad 335 may thermally couple the thermally conductive member 333 to the metal housing structure. The thermal interface pad 335 may also electrically isolate the thermally conductive member 333 from the metal housing structure.

The thermal interface pad 335 may be compressed between the thermally conductive member 333 and the internal surface of the metal housing structure. The metal housing structure may include the metal housing structure 351, and may be formed as a casted metal housing structure that includes an interface feature 500 integrally formed on the interior surface 337 of the metal housing structure 351. The thermal interface pad 335 may be mounted on the interface feature 500.

In one or more implementations, the enclosure 344 may include an enclosure (e.g., modular enclosure 290) for a modular electronic component assembly 346 for the battery pack 110. The modular electronic component assembly 346 may be configured to mechanically couple to an energy volume enclosure 205 of the battery pack 110. The battery pack may also include a plurality of battery cells 120 within the energy volume enclosure 205.

The battery pack 110 may also include a bracket 400 attached to the metal housing structure 351 for supporting the one or more heat-generating electrical components. The thermally conductive member 333 may be an overmolded insert (e.g., an aluminum insert) in the bracket. The one or more heat-generating electrical components may include at least a pair of heat-generating electrical components that are stacked and/or otherwise mounted in close proximity to each other within the enclosure, without a heat dissipating space therebetween. For example, the pair of heat-generating electrical components may include a pyrofuse 700 and a shunt 702. The metal housing structure 351 may include an external surface (e.g., exterior surface 802) and a plurality of patterned casted features (e.g., surface features 803) on the external surface, opposite a location of the thermal interface pad 335. The plurality of patterned casted features (e.g., surface features 803) may provide an increased surface area on the external surface for heat dissipation.

As illustrated in FIGS. 1A-10, a modular electronic component assembly 346 may include an enclosure 344 (e.g., including modular enclosure 290 and energy volume enclosure 205) that includes one or more metal housing structures, such as the metal housing structure 351. The modular electronic component assembly 346 may also include one or more heat-generating electrical components (e.g., battery modules 115, battery cells 120, electrical components 304, pyrofuse 700, shunt 702, and/or other electrical components) within the enclosure. The modular electronic component assembly 346 may also include a thermal interface pad 335 on an interior surface 337 of the metal housing structure 351. The modular electronic component assembly 346 may also include a thermally conductive member 333 that extends between the one or more heat-generating electrical components and the thermal interface pad 335. The thermal interface pad 335 may thermally couple the thermally conductive member 333 to the metal housing structure 351. The thermal interface pad 335 may also electrically isolate the thermally conductive member 333 from the metal housing structure 351.

In this example, the thermal interface pad 335 of the modular electronic component assembly 346 may be compressed between the thermally conductive member 333 and the interior surface 337 of the metal housing structure 351. In this example, the modular electronic component assembly 346 may also include a bracket 400 attached to the metal housing structure 351 for supporting the one or more heat-generating electrical components. The thermally conductive member 333 may be an overmolded insert in the bracket 400. In this example, the one or more heat-generating electrical components of the modular electronic component assembly 346 may include at least a pair of heat-generating electrical components that are stacked within the enclosure without a heat dissipating space therebetween. For example, the pair of heat-generating electrical components of the modular electronic component assembly 346 may include a pyrofuse 700 and a shunt 702. In this example, the metal housing structure 351 of the modular electronic component assembly 346 may include an external surface (e.g., exterior surface 802) and patterned casted features (e.g., surface features 803) on the external surface, opposite a location of the thermal interface pad 335. The patterned casted features may provide an increased surface area on the external surface for heat dissipation from the modular electronic component assembly 346.

As illustrated in FIGS. 1A-10, a vehicle 100 may include a battery pack 110 that includes an enclosure 344 (e.g., including modular enclosure 290 and energy volume enclosure 205) that includes one or more metal housing structures, such as the metal housing structure 351. The battery pack 110 of the vehicle 100 may also include one or more heat-generating electrical components (e.g., battery modules 115, battery cells 120, electrical components 304, pyrofuse 700, shunt 702, and/or other electrical components) within the enclosure. The battery pack 110 of the vehicle 100 may also include a thermal interface pad 335 on an internal surface (e.g., interior surface 337 or interior surface 339) of the metal housing structure 351. The battery pack 110 of the vehicle 100 may also include a thermally conductive member 333 that extends between the one or more heat-generating electrical components and the thermal interface pad 335. The thermal interface pad 335 may thermally couple the thermally conductive member 333 to the metal housing structure. The thermal interface pad 335 may also electrically isolate the thermally conductive member 333 from the metal housing structure.

In one or more implementations, the metal housing structure includes an external surface (e.g., exterior surface 802) having a portion 341 that is opposite a location of the thermal interface pad 335 on the internal surface and that is exposed to an external environment of the vehicle 100. In one or more implementations, the enclosure 344 includes an enclosure (e.g., modular enclosure 290) for a modular electronic component assembly 346 for the battery pack 110 of the vehicle 100. The modular electronic component assembly 346 may be configured to mechanically couple to an energy volume enclosure 205 of the battery pack 110 of the vehicle. The battery pack 110 of the vehicle 100 may also include a plurality of battery cells 120 within the energy volume enclosure 205. The battery pack 110 of the vehicle 100 may also include a bracket 400 attached to the metal housing structure 351 for supporting the one or more heat-generating electrical components. The thermally conductive member 333 may be implemented as an overmolded insert in the bracket 400.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A battery pack, comprising:
an enclosure comprising a metal housing structure;
one or more heat-generating electrical components within the enclosure;
a thermal interface pad on an internal surface of the metal housing structure; and
a thermally conductive member that extends between the one or more heat-generating electrical components and the thermal interface pad, wherein the thermal interface pad thermally couples the thermally conductive member to the metal housing structure.

2. The battery pack of claim 1, wherein the thermal interface pad electrically isolates the thermally conductive member from the metal housing structure.

3. The battery pack of claim 2, wherein the thermal interface pad is compressed between the thermally conductive member and the internal surface of the metal housing structure.

4. The battery pack of claim 1, wherein the metal housing structure comprises a casted metal housing structure comprising an interface feature integrally formed on the internal surface of the metal housing structure, wherein the thermal interface pad is mounted on the interface feature.

5. The battery pack of claim 1, wherein the enclosure comprises an enclosure for a modular electronic component assembly for the battery pack, and wherein the modular electronic component assembly is configured to mechanically couple to an energy volume enclosure of the battery pack, the battery pack further comprising a plurality of battery cells within the energy volume enclosure.

6. The battery pack of claim 1, further comprising a bracket attached to the metal housing structure for supporting the one or more heat-generating electrical components, wherein the thermally conductive member is an overmolded insert in the bracket.

7. The battery pack of claim 1, wherein the one or more heat-generating electrical components comprise at least a pair of heat-generating electrical components that are stacked within the enclosure without a heat dissipating space therebetween.

8. The battery pack of claim 7, wherein the pair of heat-generating electrical components comprise a pyrofuse and a shunt.

9. The battery pack of claim 1, wherein the metal housing structure comprises an external surface and a plurality of patterned casted features on the external surface, opposite a location of the thermal interface pad, wherein the plurality of patterned casted features provide an increased surface area on the external surface for heat dissipation.

10. A modular electronic component assembly, comprising:
an enclosure comprising a metal housing structure;
one or more heat-generating electrical components within the enclosure;
a thermal interface pad on an internal surface of the metal housing structure; and
a thermally conductive member that extends between the one or more heat-generating electrical components and the thermal interface pad, wherein the thermal interface pad thermally couples the thermally conductive member to the metal housing structure.

11. The modular electronic component assembly of claim 10, wherein the thermal interface pad electrically isolates the thermally conductive member from the metal housing structure.

12. The modular electronic component assembly of claim 11, wherein the thermal interface pad is compressed between the thermally conductive member and the internal surface of the metal housing structure.

13. The modular electronic component assembly of claim 10, further comprising a bracket attached to the metal housing structure for supporting the one or more heat-generating electrical components, wherein the thermally conductive member is an overmolded insert in the bracket.

14. The modular electronic component assembly of claim 10, wherein the one or more heat-generating electrical components comprise at least a pair of heat-generating electrical components that are stacked within the enclosure without a heat dissipating space therebetween.

15. The modular electronic component assembly of claim 14, wherein the pair of heat-generating electrical components comprise a pyrofuse and a shunt.

16. The modular electronic component assembly of claim 10, wherein the metal housing structure comprises an external surface and a plurality of patterned casted features on the external surface, opposite a location of the thermal interface pad, wherein the plurality of patterned casted features provide an increased surface area on the external surface for heat dissipation.

17. A vehicle, comprising:
a battery pack, comprising:
an enclosure comprising a metal housing structure;
one or more heat-generating electrical components within the enclosure;
a thermal interface pad on an internal surface of the metal housing structure; and
a thermally conductive member that extends between the one or more heat-generating electrical components and the thermal interface pad, wherein the thermal interface pad thermally couples the thermally conductive member to the metal housing structure.

18. The vehicle of claim 17, wherein the metal housing structure includes an external surface having a portion that is opposite a location of the thermal interface pad on the internal surface and that is exposed to an external environment of the vehicle.

19. The vehicle of claim 18, wherein the enclosure comprises an enclosure for a modular electronic component assembly for the battery pack, and wherein the modular electronic component assembly is configured to mechanically couple to an energy volume enclosure of the battery pack, the battery pack further comprising a plurality of battery cells within the energy volume enclosure.

20. The vehicle of claim 18, the battery pack further comprising a bracket attached to the metal housing structure for supporting the one or more heat-generating electrical components, wherein the thermally conductive member is an overmolded insert in the bracket.
